(19) United States
(12) Patent Application Publication
(10) Pub. No.: US 2026/0206025 A1
(43) Pub. Date: Jul. 16, 2026

(54) DOWNLINK TRANSMISSION METHOD AND APPARATUS AND READABLE STORAGE MEDIUM

(71) Applicant: Beijing Xiaomi Mobile Software Co., Ltd., Beijing (CN)

(72) Inventor: Ting FU, Beijing (CN)

(73) Assignee: Beijing Xiaomi Mobile Software Co., Ltd., Beijing (CN)

(21) Appl. No.: 19/133,078

(22) PCT Filed: Nov. 28, 2022
(86) PCT No.: PCT/CN2022/134815

§ 371 Date: May 27, 2025

(51) Int. Cl. H04W 72/21; H04L 1/1812; H04W 72/232

(52) U.S. Cl. CPC H04W 72/21; H04L 1/1812; H04W 72/232

(57) ABSTRACT

A downlink receiving method, a downlink sending method, communication apparatuses, and readable storage mediums. The method includes: running, for a plurality of physical uplink shared channels (PUSCHs) scheduled by one piece of downlink control information (DCI), one uplink retransmission timer for each group of PUSCHs, and monitoring a physical downlink control channel (PDCCH) during running of the uplink retransmission timer, where the plurality of PUSCHs are divided into at least one group of PUSCHs, and each group of PUSCHs includes one or more PUSCHs.

### CROSS-REFERENCE TO RELATED APPLICATIONS

The present disclosure is a U.S. national phase of PCT Application No. PCT/CN2022/134815 filed on Nov. 28, 2022, the content of which is hereby incorporated by reference in its entirety.

### TECHNICAL FIELD

The present disclosure relates to a field of wireless communication technologies, and in particular, to a downlink receiving method, a downlink sending method, communication apparatuses, and readable storage mediums.

### BACKGROUND

To reduce energy consumption of UE (user equipment) in a communication process, connected discontinuous reception (C-DRX), such a key feature, is introduced into 3GPP (3rd generation partnership project) new radio (NR). In the C-DRX mode, the UE does not need to continuously monitor a physical downlink control channel (PDCCH), but starts to monitor the PDCCH only when a starting time of an on-duration is reached. The UE enters an off-duration if the on-duration ends or the monitoring ends, and does not need to monitor the PDCCH in the off-duration to save energies.

### SUMMARY

In a first aspect, the present disclosure provides a downlink receiving method. The method is performed by user equipment and includes: running, for a plurality of physical uplink shared channels (PUSCHs) scheduled by one piece of downlink control information (DCI), one uplink retransmission timer for each group of PUSCHs; and monitoring a physical downlink control channel (PDCCH) during running of the uplink retransmission timer, where the plurality of PUSCHs are divided into at least one group of PUSCHs, and each group of PUSCHs includes one or more PUSCHs.

In a second aspect, the present disclosure provides a downlink sending method. The method is performed by a network device and includes: sending a physical downlink control channel (PDCCH) during running of one uplink retransmission timer for each group of PUSCHs, where each group of PUSCHs is all or a part of PUSCHs scheduled by one piece of DCI.

In a third aspect, the present disclosure provides a communication apparatus, including a processor and a memory, where the memory is configured to store a computer program, and the processor is configured to execute the computer program to implement the first aspect or any one possible design of the first aspect.

In a fourth aspect, the present disclosure provides a communication apparatus, including a processor and a memory, where the memory is configured to store a computer program, and the processor is configured to execute the computer program to implement the second aspect or any one possible design of the second aspect.

In a fifth aspect, the present disclosure provides a computer-readable storage medium. The computer-readable storage medium stores instructions (or referred to as a computer program or a program). The instructions, when invoked and executed by a computer, cause the computer to perform the first aspect or any one possible design of the first aspect.

In a sixth aspect, the present disclosure provides a computer-readable storage medium. The computer-readable storage medium stores instructions (or referred to as a computer program or a program). The instructions, when invoked and executed by a computer, cause the computer to perform the second aspect or any one possible design of the second aspect.

It should be understood that the above general description and the detailed description in the following text are only exemplary and explanatory, and cannot limit the present disclosure.

### BRIEF DESCRIPTION OF DRAWINGS

The drawings illustrated herein are used to provide a further understanding of embodiments of the present disclosure and form a part of the present disclosure. The schematic embodiments of the present disclosure and the illustration of these embodiments are used to explain embodiments of the present disclosure and do not constitute an undue limitation of embodiments of the present disclosure.

The accompanying drawings here are incorporated into the specification and form a part of this specification, show embodiments conforming to embodiments of the present disclosure and are used together with the specification to explain principles of embodiments of the present disclosure.

FIG. 1 is a schematic architectural diagram of a wireless communication system provided by an embodiment of the present disclosure.

FIG. 2 is a flowchart of a downlink transmission method shown according to an exemplary embodiment.

FIG. 3 is a flowchart of a downlink receiving method shown according to an exemplary embodiment.

FIG. 4 is a flowchart of another downlink receiving method shown according to an exemplary embodiment.

FIG. 5 is a flowchart of another downlink receiving method shown according to an exemplary embodiment.

FIG. 6 is a schematic diagram of running a timer for a PUSCH shown according to an exemplary embodiment.

FIG. 7 is a schematic diagram of running a timer for a PUSCH shown according to another exemplary embodiment.

FIG. 8 is a flowchart of another downlink receiving method shown according to an exemplary embodiment.

FIG. 9 is a flowchart of a downlink sending method shown according to an exemplary embodiment.

FIG. 10 is a block diagram of a downlink receiving apparatus shown according to an exemplary embodiment.

FIG. 11 is a block diagram of user equipment shown according to an exemplary embodiment.

FIG. 12 is a block diagram of a downlink sending apparatus shown according to an exemplary embodiment.

FIG. 13 is a block diagram of a communication apparatus shown according to an exemplary embodiment.

### DETAILED DESCRIPTION

Embodiments of the present disclosure will be further described with reference to the accompanying drawings and specific implementations.

Exemplary embodiments will be described in detail herein, with examples thereof represented in the accompanying drawings. When the following description involves the accompanying drawings, same numerals in different figures represent same or similar elements unless otherwise indicated. Implementations described in the following exemplary embodiments do not represent all implementations consistent with embodiments of the present disclosure. Rather, they are merely examples of apparatuses and methods consistent with some aspects of the present disclosure as detailed in the appended claims.

Terms used in the embodiments of the present disclosure are only for a purpose of describing specific embodiments, and are not intended to limit the embodiments of the present disclosure. Singular forms, “a/an” and “the” used in the embodiments and the appended claims of the present disclosure are also intended to include majority forms, unless the context clearly indicates other meanings. It should also be understood that the term “and/or” used herein refers to and includes any one or all possible combinations of one or more related listed items.

It should be understood that although terms, such as “first,” “second,” “third,” etc., may be used in the embodiments of the present disclosure to describe various information, such information should not be limited by these terms. These terms are only used to distinguish a same type of information from each other. For example, without departing from the scope of the embodiments of the present disclosure, first information may also be referred to as second information, and similarly, the second information may also be referred to as the first information. Depending on the context, terms “if” and “in case of” used herein may be interpreted as “when,” “while,” or “in response to determining.”

Embodiments of the present disclosure are described in detail below. Examples of the embodiments are shown in the accompanying drawings, where same or similar reference signs throughout represent same or similar elements. The embodiments described below with reference to the accompanying drawings are exemplary and intended to explain the present disclosure, but cannot be understood as limiting the present disclosure.

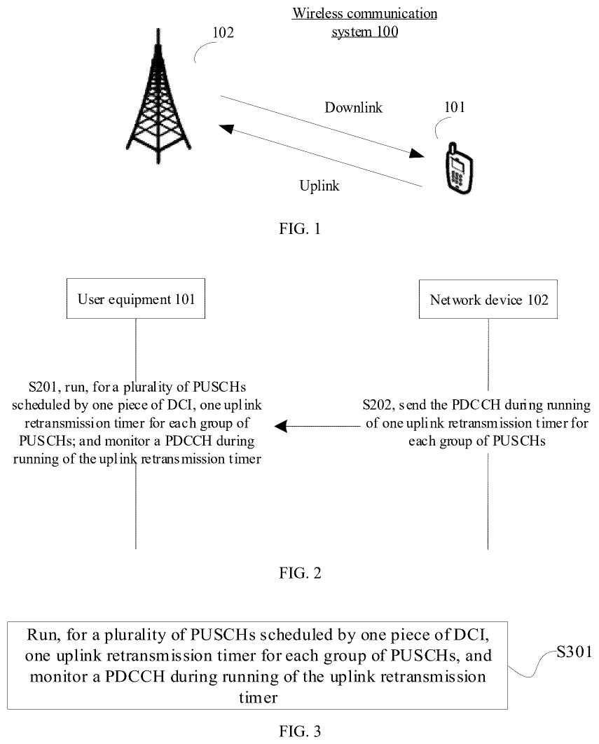

As shown in FIG. 1, a downlink transmission method provided in an embodiment of the present disclosure may be applied to a wireless communication system 100, and the wireless communication system may include user equipment 101 and a network device 102. The user equipment 101 is configured to support carrier aggregation and may be connected to a plurality of carrier units of the network device 102, including one main carrier unit and one or more auxiliary carrier units.

It should be understood that the above wireless communication system 100 may be applicable to both a low-frequency scenario and a high-frequency scenario. Application scenarios of the wireless communication system 100 include but are not limited to a long term evolution (LTE) system, an LTE frequency division duplex (FDD) system, an LTE time division duplex (TDD) system, a worldwide interoperability for micro wave access (WiMAX) communication system, a cloud radio access network (CRAN) system, a future 5th-generation (5G) system, a new radio (NR) communication system, a future evolved public land mobile network (PLMN) system, etc.

The above user equipment 101 may be a terminal, an access terminal, a terminal unit, a terminal station, a mobile station (MS), a remote station, a remote terminal, a mobile terminal, a wireless communication device, a terminal agent, a terminal device, etc. The user equipment 101 may have a wireless transceiving function, and can communicate (for example, wireless communication) with one or more network devices in one or more communication systems, and receive network services provided by the network devices, where the network device includes but is not limited to the illustrated network device 102.

The user equipment 101 may be a cellular phone, a cordless phone, a session initiation protocol (SIP) phone, a wireless local loop (WLL) station, a personal digital assistant (PDA) device, a handheld device with a wireless communication function, a computing device, another processing device connected to a wireless modem, an in-vehicle device, a wearable device, a terminal device in a future 5G network, a terminal device in a future evolved PLMN network, or the like.

The network device 102 may be an access network device (or referred to as an access network site). The access network device is a device that provides a network access function, for example, a radio access network (RAN) base station, etc. The network device 102 may specifically include a base station (BS), a radio resource management device including a base station and configured to control the base station, or the like. The network device 102 may further include a relay station (relay device), an access point, a base station in a future 5G network, a base station in a future evolved PLMN network, an NR base station, or the like. The network device 102 may be a wearable device or an in-vehicle device. The network device 102 may alternatively be a communication chip having a communication module.

For example, the network device 102 includes but is not limited to: a next generation base station (gNB) in 5G, an evolved node B (eNB) in an LTE system, a radio network controller (RNC), a node B (NB) in a WCDMA system, a radio controller in a CRAN system, a base station controller (BSC), a base transceiver station (BTS) in a GSM system or a CDMA system, a home base station (for example, a home evolved node B or a home node B (HNB)), a baseband unit (BBU), a transmitting and receiving point (TRP), a transmitting point (TP), a mobile switching center, etc.

In the case of configuring the C-DRX, scheduling of a plurality of PUSCHs by one piece of DCI is supported, each PUSCH corresponds to one uplink hybrid automatic repeat request (UL HARQ) process, and positions of time domains of a plurality of scheduled PUSCHs are in one or more slots. For example, one piece of DCI schedules 6 PUSCHs, and the 6 PUSCHs are respectively in 6 different uplink slots.

For each UL HARQ process, an uplink retransmission timer (drx-RetransmissionTimerUL) corresponding to the UL HARQ process is started at an appropriate time after the PUSCH transmission ends, and the user equipment 101 monitors the PDCCH during running of the uplink retransmission timer to obtain possible uplink data retransmission scheduling. It may be understood that PUSCH initial transmission may be correctly received by the network device 102 without uplink retransmission scheduling; however, because the UE does not know whether the transmission is correct, the UE must start a corresponding uplink retransmission timer for each UL HARQ process.

According to an existing protocol, in the case that one piece of DCI in the C-DRX schedules a plurality of PUSCHs, the user equipment 101 needs to start an uplink retransmission timer corresponding to a UL HARQ process for each PUSCH, and a union of running durations of the plurality of uplink retransmission timers is a total duration in which the user equipment 101 needs to monitor DCI scheduling retransmission. Therefore, a period in which the user equipment 101 monitors the PDCCH is relatively long, which wastes energy consumption of the user equipment 101.

An embodiment of the present disclosure provides a downlink transmission method. Referring to FIG. 2, FIG. 2 is a downlink transmission method shown according to an exemplary embodiment. As shown in FIG. 2, the method includes specifically steps S201~S202.

At step S201, the user equipment 101 runs, for a plurality of physical uplink shared channels (PUSCHs) scheduled by one piece of downlink control information (DCI), one uplink retransmission timer for each group of PUSCHs; and monitors a physical downlink control channel (PDCCH) during running of the uplink retransmission timer, where the plurality of PUSCHs are divided into at least one group of PUSCHs, and each group of PUSCHs includes one or more PUSCHs.

In some possible implementations, the plurality of PUSCHs may be divided into one group of PUSCHs, that is, the one group of PUSCHs includes the plurality of PUSCHs.

In some possible implementations, the plurality of PUSCHs are divided into two or more groups. The plurality of PUSCHs may be divided into K groups averagely, or grouped according to set grouping information, which may refer to description in the following embodiments.

At step S202, the network device 102 sends a PDCCH during running of one uplink retransmission timer for each group of PUSCHs, where each group of PUSCHs is all or a part of PUSCHs scheduled by one piece of DCI.

With reference to synchronization between the network device 102 and the user equipment 101, the network device 102 sends the PDCCH during the running of the one uplink retransmission timer, and the user equipment 101 synchronously monitors the PDCCH during the running of the one uplink retransmission timer. Therefore, step S201 and step S202 are merely illustrative, and are not limited to strictly perform the earlier-later sequence.

In some possible implementations, the DCI scheduling the PUSCHs may indicate information such as an uplink power control parameter, a time-frequency location, and an HARQ process identifier corresponding to the PUSCHs, etc.

In some possible implementations, for the plurality of PUSCHs scheduled by one piece of DCI, each PUSCH corresponds to one UL HARQ process, and each UL HARQ process corresponds to one uplink retransmission timer (drx-RetransmissionTimerUL).

In some possible implementations, the drx-RetransmissionTimerUL timer indicates a maximum duration from receiving data of the process to receiving an uplink scheduling instruction for uplink retransmission of the process.

In some possible implementations, during running of the drx-RetransmissionTimerUL timer selected to run, the user equipment 101 monitors the PDCCH to obtain possible uplink data retransmission scheduling.

For example, the user equipment 101 monitors the PDCCH during running of the drx-RetransmissionTimerUL timer, and when receiving DCI that needs to retransmit data, the user equipment 101 performs data retransmission corresponding to the process; or when receiving DCI that newly transmits data, the user equipment 101 does not need to perform the data retransmission.

In some possible implementations, for the plurality of PUSCHs scheduled by one piece of DCI, the user equipment 101 may determine how to group according to a protocol definition or an indication of the network device 102.

In an example, according to the protocol definition, the user equipment 101 considers the plurality of PUSCHs scheduled by one piece of DCI as one group, and runs one drx-RetransmissionTimerUL timer for the plurality of PUSCHs.

In another example, according to an indication of the network device 102, the user equipment 101 divides the plurality of PUSCHs scheduled by one piece of DCI into a plurality of groups, and runs one drx-RetransmissionTimerUL timer for each group of PUSCHs.

In some possible implementations, with reference to a grouping status, in each group of PUSCHs, the network device 102 sends, only during the running of the drx-RetransmissionTimerUL timer selected by the user equipment 101 to run, DCI used to schedule data retransmission or new transmission corresponding to the PUSCHs in the group. Therefore, the user equipment 101 may monitor the PDCCH only during the running of the drx-RetransmissionTimerUL timer, to obtain data retransmission scheduling corresponding to all PUSCHs in the group.

In the embodiment of the present disclosure, for a plurality of PUSCHs scheduled by one piece of DCI, the user equipment 101 runs only one uplink retransmission timer for each group of PUSCHs, and monitors the PDCCH for scheduling retransmission of the group of PUSCHs only during running of the timer. Compared with the related technology in which each of the plurality of PUSCHs starts the retransmission timer, in this embodiment of the present disclosure, for each group of PUSCHs, the user equipment 101 monitors the PDCCH for the group only in the running duration of one retransmission timer, which reduces the duration of monitoring the PDCCH by reducing the number of running of uplink retransmission timers, thereby saving energy consumption of the user equipment 101. In addition, the network device 102 sends the retransmission scheduling corresponding to PUSCHs in the group only during the running of the timer. Therefore, the user equipment 101 monitors the PDCCH only in the running duration of one retransmission timer, and does not miss retransmission scheduling corresponding to the other PUSCHs in the group.

An embodiment of the present disclosure provides a downlink receiving method, which is performed by the user equipment 101. Referring to FIG. 3, FIG. 3 is a downlink receiving method shown according to an exemplary embodiment. As shown in FIG. 3, the method includes specifically step S301.

At step S301, the user equipment 101 runs, for a plurality of PUSCHs scheduled by one piece of DCI, one uplink retransmission timer for each group of PUSCHs, and monitors a PDCCH during running of the uplink retransmission timer, where the plurality of PUSCHs are divided into at least one group of PUSCHs, and each group of PUSCHs includes one or more PUSCHs.

In some possible implementations, for the plurality of PUSCHs scheduled by one piece of DCI, each PUSCH corresponds to one UL HARQ process, and each UL HARQ process corresponds to one uplink retransmission timer (drx-RetransmissionTimerUL).

In some possible implementations, the drx-RetransmissionTimerUL timer indicates a maximum duration from receiving data of the process to receiving an uplink scheduling instruction for uplink retransmission of the process.

In some possible implementations, each UL HARQ process further corresponds to a round-trip-time timer (drx-HARQ-RTT-TimerUL). The round-trip-time timer (drx-HARQ-RTT-TimerUL) does not end, and its corresponding UL HARQ process does not perform retransmission.

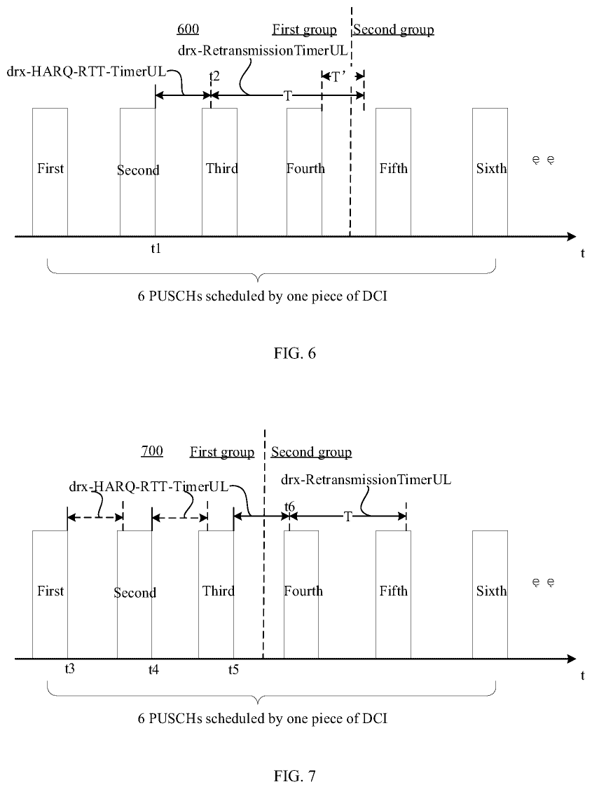

In an example, for one drx-RetransmissionTimerUL timer selected to run for each group, the drx-RetransmissionTimerUL timer starts to run after running of the round-trip-time timer (drx-HARQ-RTT-TimerUL) for the same UL HARQ process ends. For example, referring to FIG. 6, the second PUSCH in the first group of PUSCHs corresponds to a drx-RetransmissionTimerUL timer and a drx-HARQ-RTT-TimerUL. The drx-RetransmissionTimerUL timer corresponding to the second PUSCH starts to run at a time t2 after running of the drx-HARQ-RTT-TimerUL timer corresponding to the second PUSCH ends.

In some possible implementations, during the running of the drx-RetransmissionTimerUL timer, the user equipment 101 monitors the PDCCH to obtain possible uplink data retransmission scheduling.

In an example, the user equipment 101 monitors the PDCCH during running of the drx-RetransmissionTimerUL timer, and when receiving DCI that needs to retransmit data, the user equipment 101 performs data retransmission corresponding to the process; or when receiving DCI that newly transmits data, the user equipment 101 does not need to perform the data retransmission. An information field set in the DCI indicates whether the scheduled data is retransmission data or new transmission data.

In some possible implementations, for the plurality of PUSCHs scheduled by one piece of DCI, the user equipment 101 may determine how to group according to a protocol definition or an indication of the network device 102.

In an example, according to the protocol definition, the user equipment 101 considers the plurality of PUSCHs scheduled by one piece of DCI as one group, and runs one uplink retransmission timer for the plurality of PUSCHs.

In another example, according to an indication of the network device 102, the user equipment 101 divides the plurality of PUSCHs scheduled by one piece of DCI into a plurality of groups, and runs one uplink retransmission timer for each group of PUSCHs.

In the embodiment of the present disclosure, for a plurality of PUSCHs scheduled by one piece of DCI, one uplink retransmission timer is run only for each group of PUSCHs, and the PDCCH for scheduling retransmission of the group of PUSCHs is monitored only during running of the timer. For the plurality of PUSCHs, the duration of monitoring the PDCCH may be reduced by reducing the number of running of uplink retransmission timers, thereby saving energy consumption of the user equipment 101.

An embodiment of the present disclosure provides a downlink receiving method, which is performed by the user equipment 101. The method includes specifically step S301′.

At step S301′, for the plurality of PUSCHs scheduled by one piece of DCI, the user equipment 101 runs, for each group of PUSCHs, an uplink retransmission timer of an uplink hybrid automatic repeat request (HARQ) process corresponding to a first PUSCH in the group, where an ending time of the uplink retransmission timer corresponding to the first PUSCH includes an ending time of a last PUSCH in the group; and the user equipment 101 monitors the PDCCH during the running of the uplink retransmission timer.

In some possible implementations, the user equipment 101 may determine how to group the plurality of PUSCHs scheduled by one piece of DCI, according to a protocol definition or an indication of the network device 102.

In an example, the user equipment 101 considers the plurality of PUSCHs scheduled by one piece of DCI as one group according to the protocol definition. In the group, the drx-RetransmissionTimerUL timer corresponding to the first PUSCH are run for the plurality of PUSCHs.

In this example, the running duration of the drx-RetransmissionTimerUL timer is configured to include an ending time of the last PUSCH in the plurality of PUSCHs. For example, with reference to FIG. 6, an ending position of the running duration of the drx-RetransmissionTimerUL timer is after a duration T′ of the ending time of the last PUSCH in the group, to ensure that all PUSCHs in the group are received and demodulated during the running duration of the drx-RetransmissionTimerUL timer. The PDCCH may also be monitored during the running of the drx-RetransmissionTimerUL timer. For example, the DCI scheduling retransmission or new transmission corresponding to all PUSCHs in the group is monitored.

In another example, according to an indication of the network device 102, the user equipment 101 divides the plurality of PUSCHs scheduled by one piece of DCI into a plurality of groups, and runs, for each group of PUSCHs, the drx-RetransmissionTimerUL timer corresponding to the first PUSCH in the group.

In this example, the running duration of the drx-RetransmissionTimerUL timer corresponding to the first PUSCH in the group is configured to that: an ending position of the running duration T is after a duration T′ of the ending time of the last PUSCH in the group, to ensure that all PUSCHs in the group are received and demodulated during the running duration of the drx-RetransmissionTimerUL timer. Reference may be made to FIG. 6.

In some possible implementations, the first PUSCH may be protocol-defined.

For example, in a scenario in which a plurality of PUSCHs are protocol-defined as one group, the protocol may define any one PUSCH in the group of PUSCHs as the first PUSCH, for example, define a second PUSCH in the group of PUSCHs as the first PUSCH. The network device 102 may learn of the first PUSCH with reference to the protocol definition, and send the DCI scheduling retransmission during the running of the first PUSCH.

In some possible implementations, the first PUSCH may be indicated by the network device 102.

For example, the network device 102 may indicate grouping information, and indicate the first PUSCH in each group of PUSCHs. The first PUSCH may be any one PUSCH in the group.

In some possible implementations, the first PUSCH may be determined by the user equipment 101 according to an indication of the network device 102.

For example, the network device 102 indicates the grouping information, and the user equipment 101 determines the first PUSCH in each group of PUSCHs according to the grouping information, and notifies the network device 102 of the first PUSCH.

It may be understood that for the uplink retransmission timer of the first PUSCH that starts to run in each group, the network device 102 and the user equipment 101 have the same knowledge based on the first PUSCH, that is, have the same knowledge about the uplink retransmission timer started for each group.

In the embodiment of the present disclosure, the user equipment 101 may run the drx-RetransmissionTimerUL timer corresponding to the first PUSCH in each group of PUSCHs, thereby reducing the total duration of running the retransmission timer for the group to save the energy consumption of the UE.

An embodiment of the present disclosure provides a downlink receiving method, which is performed by the user equipment 101. The method includes specifically step S301″.

At step S301″, for a plurality of PUSCHs scheduled by one piece of DCI, the user equipment 101 runs, for each group of PUSCHs, an uplink retransmission timer of an uplink HARQ process corresponding to the last PUSCH in the group, and monitors a PDCCH during running of the uplink retransmission timer.

In some possible implementations, the user equipment 101 may determine how to group the plurality of PUSCHs scheduled by one piece of DCI, according to a protocol definition or an indication of the network device 102.

In an example, the user equipment 101 considers the plurality of PUSCHs scheduled by one piece of DCI as one group according to the protocol definition. In the group, the drx-RetransmissionTimerUL timer corresponding to the last PUSCH are run for the plurality of PUSCHs.

In this example, the user equipment 101 monitors the PDCCH during the running of the drx-RetransmissionTimerUL timer. For example, the DCI scheduling retransmission or new transmission corresponding to all PUSCHs is monitored.

In another example, according to an indication of the network device 102, the user equipment 101 divides the plurality of PUSCHs scheduled by one piece of DCI into a plurality of groups, and runs, for each group of PUSCHs, the drx-RetransmissionTimerUL timer corresponding to the last PUSCH in the group.

In this example, the user equipment 101 monitors the PDCCH during the running of the drx-RetransmissionTimerUL timer corresponding to the last PUSCH in the group. For example, the DCI scheduling retransmission or new transmission corresponding to all PUSCHs in the group is monitored.

In some possible implementations, with reference to the embodiment of the first PUSCH, in a manner of running, for each group of PUSCHs, the drx-RetransmissionTimerUL timer corresponding to the last PUSCH in the group, the last PUSCH may be understood as a protocol-defined first PUSCH or a first PUSCH indicated by the network device 102.

In the embodiment of the present disclosure, the user equipment 101 may run the drx-RetransmissionTimerUL timer corresponding to the last PUSCH in each group of PUSCHs, thereby saving the energy consumption of the UE.

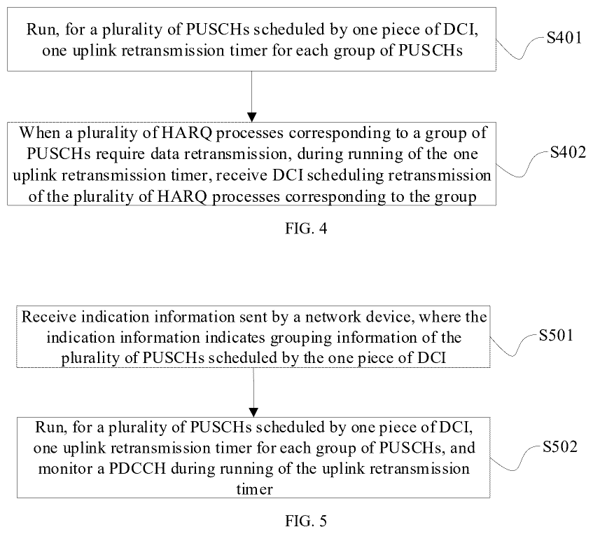

An embodiment of the present disclosure provides a downlink receiving method, which is performed by the user equipment 101. Referring to FIG. 4, FIG. 4 is a downlink receiving method shown according to an exemplary embodiment. As shown in FIG. 4, the method includes specifically steps S401~S402.

At step S401, the user equipment 101 runs, for a plurality of PUSCHs scheduled by one piece of DCI, one uplink retransmission timer for each group of PUSCHs.

At step S402, when a plurality of HARQ processes corresponding to a group of PUSCHs require data retransmission, during running of the one uplink retransmission timer, DCI scheduling retransmission of the plurality of HARQ processes corresponding to the group is received.

In some possible implementations, the plurality of PUSCHs scheduled by one piece of DCI may form one group, or may be divided into a plurality of groups.

In some possible implementations, for each group of PUSCHs, the drx-RetransmissionTimerUL timer corresponding to the first PUSCH in the group is run, or the drx-RetransmissionTimerUL timer corresponding to the last PUSCH in the group is run.

In some possible implementations, if a plurality of PUSCHs in a group all have a retransmission requirement, the network device 102 sends, during the running of a drx-RetransmissionTimerUL timer corresponding to a running PUSCH in the group, DCI scheduling HARQ processes corresponding to all PUSCHs having the retransmission requirement. During the running of the drx-RetransmissionTimerUL timer of the running HARQ process, the user equipment 101 monitors the PDCCH to monitor the DCI scheduling retransmission of a plurality of PUSCHs corresponding to HARQ processes.

In some possible implementations, when the DCI scheduling the retransmission is received, the user equipment 101 retransmits, according to an HARQ process identifier carried in the DCI scheduling the retransmission, data corresponding to the HARQ process identifier in a corresponding PUSCH.

In this embodiment of the present disclosure, during running of a drx-RetransmissionTimerUL timer started for each group, the user equipment 101 monitors DCI that may be involved by PUSCHs in the group and schedule all retransmissions.

An embodiment of the present disclosure provides a downlink receiving method, which is performed by the user equipment 101. Referring to FIG. 5, FIG. 5 is a downlink receiving method shown according to an exemplary embodiment. As shown in FIG. 5, the method includes specifically steps S501~S502.

At step S501, the user equipment 101 receives indication information sent by a network device 102, where the indication information indicates grouping information of the plurality of PUSCHs scheduled by the one piece of DCI.

At step S502, the user equipment 101 runs, for a plurality of PUSCHs scheduled by one piece of DCI, one uplink retransmission timer for each group of PUSCHs, and monitors a PDCCH during running of the uplink retransmission timer, where the plurality of PUSCHs are divided into at least one group of PUSCHs, and each group of PUSCHs includes one or more PUSCHs.

In some possible implementations, the user equipment 101 learns how to group the plurality of PUSCHs scheduled by one piece of DCI, according to an indication of the network device 102.

In some possible implementations, the network device 102 may carry indication information with DCI scheduling a plurality of PUSCHs. For example, the step S501 may include specifically the following step S501′.

At step S501′, the user equipment 101 receives DCI sent by the network device 102, where the DCI includes indication information.

In this implementation, the DCI may include an information field indicating grouping information.

In some possible implementations, the network device 102 may carry the indication information with higher layer signaling. For example, the step S501 may include specifically the following step S501″.

At step S501″, higher layer signaling sent by the network device is received, where the higher layer signaling includes the indication information.

In this implementation, the higher layer signaling may be, for example, radio resource control (RRC) signaling.

In some possible implementations, the indication information may occupy 1 or several bits.

In an example, the grouping information includes the number K of groups. The number K of groups is indicated by 1 bit. When a value of the 1 bit is 0, K is 1, and when the value of the 1 bit is 1, K is 2.

In an example, the grouping information includes a maximum number N of PUSCHs in each group of PUSCHs. The maximum number N of PUSCHs in each group of PUSCHs is indicated by 1 bit. When a value of the 1 bit is 0, N is 4, and when the value of the 1 bit is 1, N is 6.

In some possible implementations, the grouping information includes at least one of:
the number K of the at least one group;
the number M of PUSCHs scheduled by each piece of DCI; or
a maximum number N of PUSCHs in each group of PUSCHs.

In this implementation, the network device 102 may directly indicate the number K. Alternatively, the network device 102 may indicate only M and N, and K is determined based on M and N.

In this implementation, the maximum number N means that the number of PUSCHs in any one group of PUSCHs is at most N and cannot be greater than N.

In this implementation, the grouping information may further indicate a first PUSCH in each group of PUSCHs, for example, the first PUSCH is the last PUSCH in the group, or any one PUSCH.

In some possible implementations, when K is 1, each group of PUSCHs includes all PUSCHs scheduled by the one piece of DCI.

In this implementation, when K is 1, a plurality of PUSCHs scheduled by one piece of DCI form one group. The user equipment 101 may run one drx-RetransmissionTimerUL timer for the group of PUSCHs and monitor the PDCCH during the running of the timer.

In this implementation, the drx-RetransmissionTimerUL timer corresponding to the last PUSCH are run for the plurality of PUSCHs.

In some possible implementations, the number of the PUSCHs scheduled by each piece of DCI is M, the number of the PUSCHs in each group of PUSCHs is less than or equal to the maximum number N, and the number K of the at least one group meets:

$$K = ⌈ \frac{M}{N} ⌉ .$$

In this implementation, “┌ ┐” represents a round-up operation.

In this implementation, when the grouping information includes M and N, K may be determined based on M and N.

In this implementation, when M<=N, K is 1, that is, the M PUSCHs form one group.

In this implementation, when M>N and K is greater than or equal to 2, that is, the M PUSCHs are divided into two or more groups.

In some possible implementations, the number of PUSCHs in the last group of PUSCHs is:

$$M - ( ⌈ \frac{M}{N} ⌉ - 1 ) * N .$$

In this implementation, when the M PUSCHs are divided into only one group, the number of PUSCHs in the last group is M.

In this implementation, when the M PUSCHs are divided into at least two groups, except the last group of PUSCHs, the number of PUSCHs included in the remaining groups is the maximum number N.

In this implementation, the number of PUSCHs in the last group may be less than N.

In the embodiment of the present disclosure, with reference to the indication information of the network device 102, the user equipment 101 may group a plurality of PUSCHs scheduled by one piece of DCI, so that only one drx-RetransmissionTimerUL timer is started for each group after grouping, thereby effectively saving the energy.

For ease of understanding the grouping manner in the embodiments of the present disclosure, several examples are listed below.

### First Example

As shown in the timing diagram 600 in FIG. 6, when one piece of DCI schedules 6 PUSCHs, that is, M=6, and the maximum number N of PUSCHs in each group is 4, K is 2, and the 6 PUSCHs is divided into two groups.

In this example, if the number of PUSCHs in one group is 4, the number of PUSCHs in the other group is 2. A drx-RetransmissionTimerUL timer corresponding to one PUSCH is started for each group.

### Second Example

As shown in the timing diagram 700 in FIG. 7, when one piece of DCI schedules 6 PUSCHs, that is, M=6, and the maximum number N of PUSCHs in each group is 4, K is 2, and the 6 PUSCHs is divided into two groups.

In this example, if the number of PUSCHs in one group is less than N, for example, 3, the number of PUSCHs in the other group is 3. A drx-RetransmissionTimerUL timer corresponding to one PUSCH is started for each group.

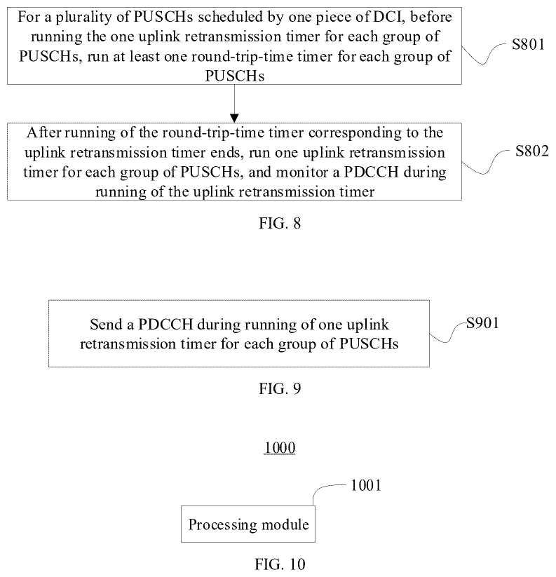

An embodiment of the present disclosure provides a downlink receiving method, which is performed by the user equipment 101. Referring to FIG. 8, FIG. 8 is a downlink receiving method shown according to an exemplary embodiment. As shown in FIG. 8, the method includes specifically steps S801~S802.

At step S801, for a plurality of PUSCHs scheduled by one piece of DCI, the user equipment 101 runs, before running the one uplink retransmission timer for each group of PUSCHs, at least one round-trip-time timer for each group of PUSCHs.

At step S802, after running of the round-trip-time timer corresponding to the uplink retransmission timer ends, one uplink retransmission timer is run for each group of PUSCHs, and a PDCCH is monitored during running of the uplink retransmission timer.

The plurality of PUSCHs are divided into at least one group of PUSCHs, and each group of PUSCHs includes one or more PUSCHs.

In some possible implementations, for the plurality of PUSCHs scheduled by one piece of DCI, each PUSCH corresponds to one UL HARQ process, and each UL HARQ process corresponds to one round-trip-time timer (drx-HARQ-RTT-TimerUL) and one uplink retransmission timer (drx-RetransmissionTimerUL).

In some possible implementations, the drx-HARQ-RTT-TimerUL timer does not end, and its corresponding UL HARQ process does not perform retransmission. During the running of the drx-HARQ-RTT-TimerUL timer, the user equipment 101 does not need to monitor the PDCCH.

In some possible implementations, for a drx-RetransmissionTimerUL timer selected to run, the drx-RetransmissionTimerUL timer starts to run after the drx-HARQ-RTT-TimerUL timer corresponding to the HARQ process ends.

In some possible implementations, running the at least one round-trip-time timer for each group of PUSCHs in step S801 includes:
running a round-trip-time timer corresponding to one uplink retransmission timer; or running round-trip-time timers corresponding to all of PUSCHs in the each group of PUSCHs.

In this implementation, when a drx-RetransmissionTimerUL timer running for any one group is selected, only a drx-HARQ-RTT-TimerUL timer corresponding to the drx-RetransmissionTimerUL timer may be run, or a drx-HARQ-RTT-TimerUL timer of a HARQ process corresponding to each PUSCH may be run.

For ease of understanding the embodiments of the present disclosure, several examples are listed below.

### First Example

Still with reference to the example in FIG. 6, when one piece of DCI schedules 6 PUSCHs, that is, M=6, and the maximum number N of PUSCHs in each group is 4, K is 2, and the 6 PUSCHs is divided into two groups. If the number of PUSCHs in one group is 4, the number of PUSCHs in the other group is 2. A drx-RetransmissionTimerUL timer corresponding to one PUSCH is started for each group.

In this example, it is assumed that in the first group of PUSCHs, a drx-RetransmissionTimerUL timer corresponding to a second PUSCH in the first group is started, an ending position of the running duration T of the drx-RetransmissionTimerUL timer is after a duration T′ of the ending time of the last PUSCH in the first group, to ensure that all PUSCHs in the group are received and demodulated during the running duration of the drx-RetransmissionTimerUL timer.

In this example, only the drx-HARQ-RTT-TimerUL timer corresponding to the second PUSCH is run. Starting from the time t1 when the second PUSCH ends, the drx-HARQ-RTT-TimerUL timer is first run, and the drx-RetransmissionTimerUL timer starts to run at the time t2 when the drx-HARQ-RTT-TimerUL timer ends running.

During the running duration T of the drx-RetransmissionTimerUL timer corresponding to the second PUSCH, the UE monitors DCI scheduling retransmission of three PUSCHs in the first group.

### Second Example

Still with reference to FIG. 7, when one piece of DCI schedules 6 PUSCHs, that is, M=6, and the maximum number N of PUSCHs in each group is 4, K is 2, and the 6 PUSCHs is divided into two groups. If the number of PUSCHs in one group is less than N, for example, 3, the number of PUSCH in the other group is 3. A drx-RetransmissionTimerUL timer corresponding to one PUSCH is started for each group.

In this example, it is assumed that in a first group of PUSCHs, a drx-RetransmissionTimerUL timer corresponding to a last PUSCH in the first group is started.

In this example, drx-HARQ-RTT-TimerUL timers corresponding to all PUSCHs in the first group are all run.

Starting from the ending time t3 of the first PUSCH in the first group, the drx-HARQ-RTT-TimerUL timer corresponding to the first PUSCH is run, but the drx-RetransmissionTimerUL timer corresponding to the first PUSCH is not run.

Starting from the ending time t4 of the second PUSCH in the first group, the drx-HARQ-RTT-TimerUL timer corresponding to the second PUSCH is run, but the drx-RetransmissionTimerUL timer corresponding to the second PUSCH is not run.

Starting from the ending time t5 of the last PUSCH in the first group, a drx-HARQ-RTT-TimerUL timer corresponding to the last PUSCH is run, and a drx-RetransmissionTimerUL timer corresponding to the last PUSCH starts to run after a time t6 when the drx-HARQ-RTT-TimerUL timer ends running.

During the running duration T of the last drx-RetransmissionTimerUL timer, the UE monitors DCI scheduling retransmission of three PUSCHs in the first group.

In the embodiment of the present disclosure, during running of the drx-HARQ-RTT-TimerUL timers, the user equipment 101 does not monitor the PDCCH, so the smaller the number of running of drx-HARQ-RTT-TimerUL timers is, the fewer the starting operations of the UE are, and the smaller the energy consumption corresponding to the round-trip-time timers is.

An embodiment of the present disclosure provides a downlink sending method, which is performed by a network device 102. Referring to FIG. 9, FIG. 9 is a downlink sending method shown according to an exemplary embodiment. As shown in FIG. 9, the method includes specifically step S901.

At step S901, the network device 102 sends a PDCCH during running of one uplink retransmission timer for each group of PUSCHs, where each group of PUSCHs is all or a part of PUSCHs scheduled by one piece of DCI.

In some possible implementations, the DCI scheduling the PUSCHs may indicate information such as an uplink power control parameter, a time-frequency location, and an HARQ process identifier corresponding to the PUSCHs, etc.

In some possible implementations, for the plurality of PUSCHs scheduled by one piece of DCI, each PUSCH corresponds to one UL HARQ process, and each UL HARQ process corresponds to one uplink retransmission timer (drx-RetransmissionTimerUL).

In some possible implementations, with reference to a grouping status, the network device 102 sends, during the running of the drx-RetransmissionTimerUL timer selected by the user equipment 101 to run, DCI used to schedule data retransmission or new transmission.

In this embodiment of the present disclosure, for each group of PUSCHs, the network device 102 sends the PDCCH only during running of one uplink retransmission timer, so that the duration of monitoring the PDCCH by the user equipment 101 may be reduced, thereby saving energy consumption.

An embodiment of the present disclosure provides a downlink sending method, which is performed by a network device 102. The method includes specifically step S901a.

At step S901a, the network device 102 sends the PDCCH during running of an uplink retransmission timer corresponding to a first PUSCH in each group of PUSCHs; where an ending time of the uplink retransmission timer corresponding to the first PUSCH includes an ending time of a last PUSCH in the group in which the first PUSCH is located.

In some possible implementations, a plurality of PUSCHs scheduled by one piece of DCI may be divided into one or more groups, that is, each group of PUSCHs is all or a part of PUSCHs scheduled by one piece of DCI.

In some possible implementations, the user equipment 101 may run a drx-RetransmissionTimerUL timer corresponding to the first PUSCH in a plurality of PUSCHs scheduled by one piece of DCI. The network device 102 sends, in combination with a position of a time domain of the drx-RetransmissionTimerUL timer, DCI scheduling retransmission in an interval of the time domain corresponding to running of the timer.

In some possible implementations, after grouping a plurality of PUSCH scheduled by one piece of DCI, the user equipment 101 may run, for each group, a drx-RetransmissionTimerUL timer corresponding to the first PUSCH in the group. In the group, the network device 102 sends, in combination with a position of a time domain of a running drx-RetransmissionTimerUL timer, DCI scheduling retransmission of the group of PUSCHs in a corresponding interval of the time domain.

In some possible implementations, the first PUSCH may be protocol-defined.

For example, in a scenario in which a plurality of PUSCHs are protocol-defined as one group, the protocol may define any one PUSCH in the group of PUSCHs as the first PUSCH, for example, define a second PUSCH in the group of PUSCHs as the first PUSCH. The network device 102 may learn of the first PUSCH with reference to the protocol definition, and send the DCI scheduling retransmission during the running of the first PUSCH.

In some possible implementations, the first PUSCH may be indicated by the network device 102.

For example, the network device 102 may indicate grouping information, and indicate the first PUSCH in each group of PUSCHs. The first PUSCH may be any one PUSCH in the group.

In some possible implementations, the first PUSCH may be determined by the user equipment 101 according to an indication of the network device 102.

For example, the network device 102 indicates the grouping information, and the user equipment 101 determines the first PUSCH in each group of PUSCHs according to the grouping information, and notifies the network device 102 of the first PUSCH.

It may be understood that for the uplink retransmission timer of the first PUSCH that starts to run in each group, the network device 102 and the user equipment 101 have the same knowledge based on the first PUSCH, that is, have the same knowledge about the uplink retransmission timer started for each group.

In this embodiment of the present disclosure, in a scenario in which the user equipment 101 runs a drx-RetransmissionTimerUL timer corresponding to a first PUSCH in each group of PUSCHs, the network device 102 sends the DCI scheduling retransmission in a corresponding interval of the time domain.

An embodiment of the present disclosure provides a downlink sending method, which is performed by a network device 102. The method includes specifically step S901b.

At step S901b, the network device 102 sends the PDCCH during running of an uplink retransmission timer of an uplink HARQ process corresponding to a last PUSCH in each group of PUSCHs.

In some possible implementations, a plurality of PUSCHs scheduled by one piece of DCI may be divided into one or more groups, that is, each group of PUSCHs is all or a part of PUSCHs scheduled by one piece of DCI.

In some possible implementations, the user equipment 101 may run a drx-RetransmissionTimerUL timer corresponding to the last PUSCH in a plurality of PUSCHs scheduled by one piece of DCI. The network device 102 sends DCI scheduling retransmission during running of a drx-RetransmissionTimerUL timer corresponding to the last PUSCH.

In some possible implementations, after grouping a plurality of PUSCH scheduled by one piece of DCI, the user equipment 101 may run, for each group, a drx-RetransmissionTimerUL timer corresponding to the last PUSCH in the group. In the group, the network device 102 sends, during the running of the drx-RetransmissionTimerUL timer corresponding to the last PUSCH, DCI scheduling retransmission of the group of PUSCHs.

In this embodiment of the present disclosure, in a scenario in which the user equipment 101 runs a drx-RetransmissionTimerUL timer corresponding to a last PUSCH in each group of PUSCHs, the network device 102 sends DCI scheduling retransmission during running of the drx-RetransmissionTimerUL timer of the last PUSCH.

An embodiment of the present disclosure provides a downlink sending method, which is performed by a network device 102. The method includes specifically step S901c.

At step S901c, when a plurality of HARQ processes corresponding to a group of PUSCHs require data retransmission, the network device 102 sends, during running of the one uplink retransmission timer, DCI scheduling retransmission of the plurality of HARQ processes. Each group of PUSCHs is all or a part of PUSCHs scheduled by one piece of DCI.

In some possible implementations, for each group of PUSCHs, the network device 102 may carry, in the DCI scheduling retransmission, all HARQ process identifiers that need to be retransmitted in the group.

An embodiment of the present disclosure provides a downlink sending method, which is performed by a network device 102. The method includes specifically steps S900-S901.

At step S900, the network device 102 sends indication information to the user equipment 101, where the indication information indicates grouping information of the plurality of PUSCHs scheduled by the one piece of DCI.

At step S901, the network device 102 sends a PDCCH during running of one uplink retransmission timer for each group of PUSCHs, where each group of PUSCHs is all or a part of PUSCHs scheduled by one piece of DCI.

In some possible implementations, the network device 102 indicates a parameter related to grouping, so that the user equipment 101 may group a plurality of PUSCHs scheduled by one piece of DCI.

In some possible implementations, the step S900 may include specifically the following step S900′.

At step S900′, the network device 102 sends DCI to the user equipment 101, where the DCI includes indication information.

In this implementation, the DCI may include an information field indicating grouping information.

In some possible implementations, the step S900 may include specifically the following step S900″.

At step S900″, the network device 102 sends higher layer signaling to the user equipment 101, where the higher layer signaling includes indication information.

In this implementation, the higher layer signaling may be, for example, radio resource control (RRC) signaling.

In some possible implementations, the grouping information includes at least one of:
the number K of the at least one group;
the number M of PUSCHs scheduled by each piece of DCI; or
a maximum number N of PUSCHs in each group of PUSCHs.

In this implementation, the network device 102 may directly indicate the number K. Alternatively, the network device 102 may indicate only M and N, and K is determined based on M and N.

In this implementation, the maximum number N means that the number of PUSCHs in any one group of PUSCHs is at most N and cannot be greater than N.

In this implementation, the grouping information may further indicate a first PUSCH in each group of PUSCHs, for example, the first PUSCH is the last PUSCH in the group, or any one PUSCH.

Based on the same concept as the above method embodiments, an embodiment of the present disclosure further provides a downlink receiving apparatus. The apparatus may have a function of the user equipment 101 in the above method embodiments, and may be configured to perform the steps performed by the user equipment 101 provided in the above embodiments. The functions may be implemented by hardware, or may be implemented by software or hardware executing corresponding software. The hardware or software includes one or more modules corresponding to the above functions.

In a possible implementation, the apparatus 1000 shown in FIG. 10 may be used as the user equipment 101 in the above method embodiments, and perform the steps performed by the user equipment 101 in the above method embodiments. As shown in FIG. 10, the apparatus 1000 may include a processing module 1001, where the processing module 1001 may be configured to support the communication apparatus for communication.

When performing the steps implemented by the user equipment 101, the processing module 1001 is configured to: run one uplink retransmission timer for each group of PUSCHs for a plurality of PUSCHs scheduled by one piece of DCI, and monitor a PDCCH during running of the uplink retransmission timer, where the plurality of PUSCHs include at least one group of PUSCHs.

When the downlink receiving apparatus is the user equipment 101, a structure of the apparatus may also be shown in FIG. 11. The apparatus 1100 may be a mobile phone, a computer, a digital broadcast terminal, a message transceiving device, a game console, a tablet device, a medical device, a fitness device, a personal digital assistant, etc.

Referring to FIG. 11, the apparatus 1100 may include one or more of the following components: a processing component 1102, a memory 1104, a power component 1106, a multimedia component 1108, an audio component 1110, an input/output (I/O) interface 1112, a sensor component 1114, and a communication component 1116.

The processing component 1102 typically controls the overall operation of the apparatus 1100, such as operations associated with display, phone calls, data communication, camera operations, and recording operations. The processing component 1102 may include one or more processors 1120 to execute instructions to complete all or part of the steps in the above methods. Additionally, the processing component 1102 may include one or more modules to facilitate interaction between the processing component 1102 and other components. For example, the processing component 1102 may include a multimedia module to facilitate interaction between the multimedia component 1108 and the processing component 1102.

The memory 1104 is configured to storing various types of data to support operations of the device 1100. Examples of such data include instructions, contact data, phonebook data, messages, pictures, videos, etc., for any one application program or method operating on the apparatus 1100. The memory 1104 may be realized by any one type of volatile or non-volatile storage device or their combination, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disk.

The power component 1106 provides power to various components of the apparatus 1100. The power component 1106 may include a power supply management system, one or more power supplies, and other components that are associated with generating, managing, and distributing power for the apparatus 1100.

The multimedia component 1108 includes a screen providing an output interface between the apparatus 1100 and the user. In some embodiments, the screen may include a liquid crystal display (LCD) and a touch panel (TP). If the screen includes the touch panel, the screen may be implemented as a touch screen, to receive an input signal from the user. The touch panel includes one or more touch sensors to sense the touch, the slide, and the gesture on the touch panel. The touch sensor may not only sense the boundary of the touch or slide action, but also detect the duration and pressure related to the touch or slide operation. In some embodiments, the multimedia component 1108 includes a front facing camera and/or a rear facing camera. When the device 1100 is in an operation mode, such as a shooting mode or a video mode, the front facing camera and/or the rear facing camera may receive external multimedia data. Each of the front facing camera and rear facing camera may be a fixed optical lens system or has a focal length and an optical zoom capability.

The audio component 1110 is configured to output and/or input audio signals. For example, the audio component 1110 includes a microphone (MIC). The microphone is configured for receiving external audio signals when the apparatus 1000 is in the operating mode, such as a call mode, a recording mode, and a speech recognition mode. The received audio signals may be further stored in the memory 1104 or sent via the communication component 1116. In some embodiments, the audio component 1110 also includes a speaker for outputting the audio signals.

The I/O interface 1112 provides an interface between the processing component 1102 and peripheral interface modules. The peripheral interface modules may be keyboards, click wheels, buttons, etc. These buttons may include but are not limited to: a home button, a volume button, a start button, and a lock button.

The sensor component 1114 includes one or more sensors to provide various aspects of state assessment for the apparatus 1100. For example, the sensor component 1114 may detect an open/closed state of the apparatus 1100, relative positioning of components that are for example a display and keypad of the apparatus 1100. The sensor component 1114 may also detect a position change of the apparatus 1100 or of a component of the apparatus 1100, presence or absence of the user contacting with the apparatus 1100, an orientation or acceleration/deceleration of the apparatus 1100, and a temperature change of the apparatus 1100. The sensor component 1114 may include a proximity sensor configured to detect the presence of nearby objects without any one physical contact. The sensor component 1114 may also include a light sensor, such as a CMOS or CCD image sensor, for use in an imaging application. In some embodiments, the sensor component 1114 may also include an acceleration sensor, a gyroscope sensor, a magnetic sensor, a pressure sensor, or a temperature sensor.

The communication component 1116 is configured for facilitating wired or wireless communication between the apparatus 1100 and other devices. The apparatus 1100 may access a wireless network based on a communication standard, such as WiFi, 2G, 3G, or a combination of them. In an exemplary embodiment, the communication component 1116 receives, via a broadcast channel, a broadcast signal or broadcast related information from an external broadcast management system. In an exemplary embodiment, the communication component 1116 further includes a near-field communication (NFC) module to facilitate short-range communication. For example, the NFC module may be implemented based on a radio frequency identification (RFID) technology, an infrared data association (IrDA) technology, an ultra-wideband (UWB) technology, a Bluetooth (BT) technology, and other technologies.

In an exemplary embodiment, the apparatus 1100 may be implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic components to perform the above methods.

In an exemplary embodiment, a non-transitory computer-readable storage medium including instructions is also provided, such as the memory 1104 including the instructions. The above instructions can be executed by the processor 1120 of the apparatus 1100 to complete the above methods. For example, the non-transitory computer-readable storage medium may be a ROM, a random access memory (RAM), a CD-ROM, a magnetic tape, a floppy disk, an optical data storage device, etc.

Based on the same concept as the above method embodiments, an embodiment of the present disclosure further provides a downlink sending apparatus. The apparatus may have a function of the network device 102 in the above method embodiments, and may be configured to perform the steps performed by the network device 102 provided in the above embodiments. The functions may be implemented by hardware, or may be implemented by software or hardware executing corresponding software. The hardware or software includes one or more modules corresponding to the above functions.

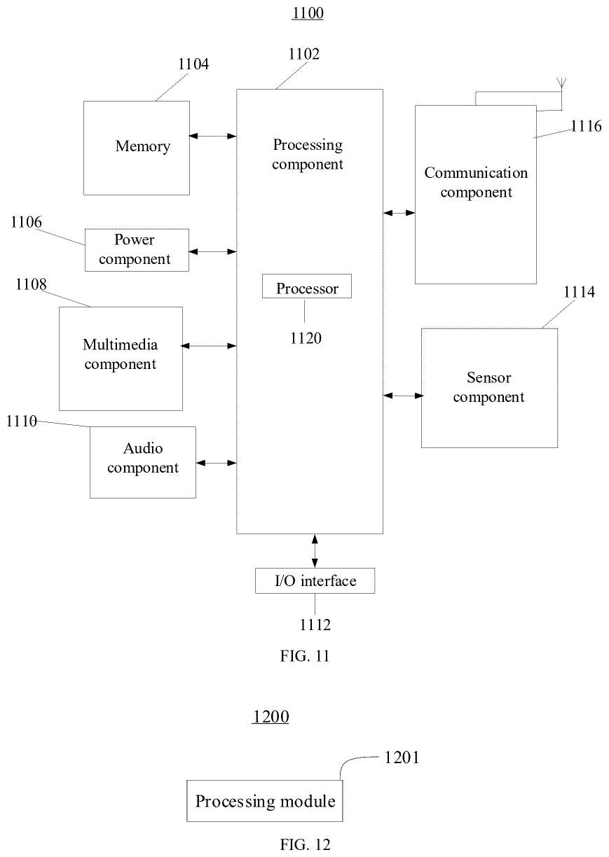

In a possible implementation, the communication apparatus 1200 shown in FIG. 12 may be used as the network device 102 in the above method embodiments, and perform the steps performed by the network device 102 in the above method embodiments. As shown in FIG. 12, the communication apparatus 1200 may include a processing module 1201, where the processing module 1201 may be used for the communication apparatus to perform a processing operation, for example, generate information/messages that need to be sent, or process a received signal to obtain information/messages.

When performing the steps implemented by the network device 102, the processing module 1201 is configured to send the PDCCH during running of one uplink retransmission timer for each group of PUSCHs, where each group of PUSCHs is all or a part of PUSCHs scheduled by one piece of DCI.

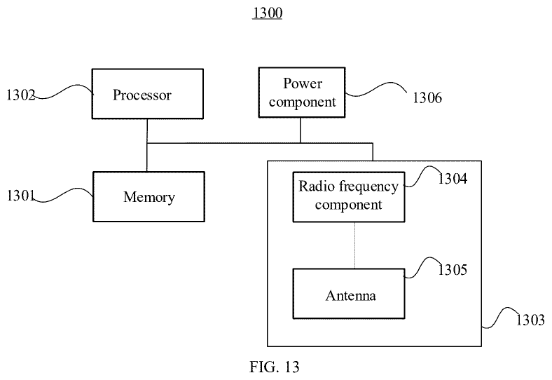

When the communication apparatus is the network device 102, a structure of the communication apparatus may also be shown in FIG. 13. A base station is used as an example to describe a structure of the communication apparatus. As shown in FIG. 13, the apparatus 1300 includes a memory 1301, a processor 1302, a transceiving component 1303, and a power component 1306. The memory 1301 is coupled to the processor 1302, and may be configured to store a program and data necessary for the communication apparatus 1300 to implement various functions. The processor 1302 is configured to support the communication apparatus 1300 to perform corresponding functions in the above methods, and the functions may be implemented by invoking the program stored in the memory 1301. The transceiving component 1303 may be a wireless transceiver, and may be configured to support the communication apparatus 1300 to receive signaling and/or data and send the signaling and/or data through a wireless air interface. The transceiving component 1303 may also be referred to as a transceiving unit or a communication unit, and the transceiving component 1303 may include a radio frequency component 1304 and one or more antennas 1305. The radio frequency component 1304 may be a remote radio unit (RRU), which may specifically be used to transmit radio frequency signals and used for conversation between the radio frequency signals and baseband signals. The one or more antennas 1305 may specifically be used to radiate and receive the radio frequency signals.

When the communication apparatus 1300 needs to send data, the processor 1302 may perform baseband processing on to-be-sent data, and then output a baseband signal to the radio frequency unit, and the radio frequency unit performs radio frequency processing on the baseband signal and then sends the radio frequency signal in a form of electromagnetic wave through the antenna. When data is sent to the communication apparatus 1300, the radio frequency unit receives a radio frequency signal through the antenna, converts the radio frequency signal into a baseband signal, and outputs the baseband signal to the processor 1302. The processor 1302 converts the baseband signal into data and processes the data.

In a first aspect, the present disclosure provides a downlink receiving method. The method is performed by user equipment and includes: running, for a plurality of physical uplink shared channels (PUSCHs) scheduled by one piece of downlink control information (DCI), one uplink retransmission timer for each group of PUSCHs; and monitoring a physical downlink control channel (PDCCH) during running of the uplink retransmission timer, where the plurality of PUSCHs are divided into at least one group of PUSCHs, and each group of PUSCHs includes one or more PUSCHs.

In the methods of the present disclosure, for a plurality of PUSCHs scheduled by one piece of DCI, one uplink retransmission timer is run only for each group of PUSCHs, and the PDCCH for scheduling retransmission of the group of PUSCHs is monitored only during running of the timer. For the plurality of PUSCHs, the duration of monitoring the PDCCH may be reduced by reducing the number of running of uplink retransmission timers, thereby saving energy consumption of the user equipment.

In some possible implementations, the running one uplink retransmission timer for each group of PUSCHs, includes: running, for each group of PUSCHs, an uplink retransmission timer of an uplink hybrid automatic repeat request (HARQ) process corresponding to a first PUSCH in the group, where an ending time of the uplink retransmission timer corresponding to the first PUSCH includes an ending time of a last PUSCH in the group.

In some possible implementations, the running one uplink retransmission timer for each group of PUSCHs, includes: running, for each group of PUSCHs, an uplink retransmission timer of an uplink HARQ process corresponding to a last PUSCH in the group.

In some possible implementations, the monitoring a physical downlink control channel (PDCCH) during running of the uplink retransmission timer, includes: when a plurality of HARQ processes corresponding to a group of PUSCHs require data retransmission, receiving, during running of the one uplink retransmission timer, DCI scheduling retransmission of the plurality of HARQ processes corresponding to the group.

In some possible implementations, the method further includes: receiving indication information sent by a network device, where the indication information indicates grouping information of the plurality of PUSCHs scheduled by the one piece of DCI.

In some possible implementations, the receiving indication information sent by a network device, includes one of: receiving the DCI sent by the network device, where the DCI includes the indication information; or receiving higher layer signaling sent by the network device, where the higher layer signaling includes the indication information.

In some possible implementations, the grouping information includes at least one of: the number K of the at least one group; the number M of PUSCHs scheduled by each piece of DCI; or a maximum number N of PUSCHs in each group of PUSCHs.

In some possible implementations, when K is 1, each group of PUSCHs includes all PUSCHs scheduled by the one piece of DCI.

In some possible implementations, the number of the PUSCHs scheduled by each piece of DCI is M, the number of the PUSCHs in each group of PUSCHs is less than or equal to the maximum number N, and the number K of the at least one group meets:

$$K = ⌈ \frac{M}{N} ⌉ .$$

In some possible implementations, the number of PUSCHs in the last group of PUSCHs is:

$$M - ( ⌈ \frac{M}{N} ⌉ - 1 ) * N .$$

In some possible implementations, the method further includes: running, before running the one uplink retransmission timer for each group of PUSCHs, at least one round-trip-time timer for each group of PUSCHs.

In some possible implementations, running the at least one round-trip-time timer for each group of PUSCHs, includes: running a round-trip-time timer corresponding to the one uplink retransmission timer; or running round-trip-time timers corresponding to all of PUSCHs in the each group of PUSCHs.

In a second aspect, the present disclosure provides a downlink sending method. The method is performed by a network device and includes: sending a physical downlink control channel (PDCCH) during running of one uplink retransmission timer for each group of PUSCHs, where each group of PUSCHs is all or a part of PUSCHs scheduled by one piece of DCI.

In the methods of the present disclosure, for each group of PUSCHs, the network device sends the PDCCH only during running of one uplink retransmission timer, so that the duration of monitoring the PDCCH by the terminal may be reduced, thereby saving energy consumption.

In some possible implementations, the sending a physical downlink control channel (PDCCH) during running of one uplink retransmission timer for each group of PUSCHs, includes: sending the PDCCH during running of an uplink retransmission timer corresponding to a first PUSCH in each group of PUSCHs; where an ending time of the uplink retransmission timer corresponding to the first PUSCH includes an ending time of a last PUSCH in the group in which the first PUSCH is located.

In some possible implementations, the sending a physical downlink control channel (PDCCH) during running of one uplink retransmission timer for each group of PUSCHs, includes: sending the PDCCH during running of an uplink retransmission timer of an uplink HARQ process corresponding to a last PUSCH in each group of PUSCHs.

In some possible implementations, the sending a physical downlink control channel (PDCCH) during running of one uplink retransmission timer for each group of PUSCHs, includes: when a plurality of HARQ processes corresponding to a group of PUSCHs require data retransmission, sending, during running of the one uplink retransmission timer, DCI scheduling retransmission of the plurality of HARQ processes.

In some possible implementations, the method further includes: sending indication information to user equipment, where the indication information indicates grouping information of the plurality of PUSCHs scheduled by the one piece of DCI.

In some possible implementations, the sending indication information to the UE, includes one of: sending the DCI to the user equipment, where the DCI includes the indication information; or sending higher layer signaling to the user equipment, where the higher layer signaling includes the indication information.

In some possible implementations, the grouping information includes at least one of: the number K of the at least one group; the number M of PUSCHs scheduled by each piece of DCI; or a maximum number N of PUSCHs in each group of PUSCHs.

In a third aspect, the present disclosure provides a downlink receiving apparatus. The apparatus may be configured to perform the steps performed by the user equipment in the first aspect or any one possible design of the first aspect. The user equipment may implement various functions in the various methods in a form of the hardware structure, the software module, or a combination of the hardware structure and the software module.

When the apparatus shown in the third aspect is implemented by the software module, the apparatus may include a processing module, where the processing module may be used for the communication apparatus to perform a processing operation, for example, generate information/messages that need to be sent, or process a received signal to obtain information/messages.

When performing the steps in the first aspect, the processing module is configured to run, for a plurality of physical uplink shared channels (PUSCHs) scheduled by one piece of downlink control information (DCI), one uplink retransmission timer for each group of PUSCHs, and monitor a physical downlink control channel (PDCCH) during running of the uplink retransmission timer, where the plurality of PUSCHs are divided into at least one group of PUSCHs, and each group of PUSCHs includes one or more PUSCHs.

In a fourth aspect, the present disclosure provides a downlink sending apparatus. The apparatus may be configured to perform the steps performed by the network device in the second aspect or any one possible design of the second aspect. The network device may implement various functions in the various methods in a form of the hardware structure, the software module, or a combination of the hardware structure and the software module.

When the apparatus shown in the fourth aspect is implemented by the software module, the apparatus may include a processing module, where the processing module may be used for the communication apparatus to perform a processing operation, for example, generate information/messages that need to be sent, or process a received signal to obtain information/messages.

When performing the steps in the second aspect, the processing module is configured to send the PDCCH during running of one uplink retransmission timer for each group of PUSCHs, where each group of PUSCHs is all or a part of PUSCHs scheduled by one piece of DCI.

In a fifth aspect, the present disclosure provides a communication apparatus, including a processor and a memory, where the memory is configured to store a computer program, and the processor is configured to execute the computer program to implement the first aspect or any one possible design of the first aspect.

In a sixth aspect, the present disclosure provides a communication apparatus, including a processor and a memory, where the memory is configured to store a computer program, and the processor is configured to execute the computer program to implement the second aspect or any one possible design of the second aspect.

In a seventh aspect, the present disclosure provides a computer-readable storage medium. The computer-readable storage medium stores instructions (or referred to as a computer program or a program). The instructions, when invoked and executed by a computer, cause the computer to perform the first aspect or any one possible design of the first aspect.

In an eighth aspect, the present disclosure provides a computer-readable storage medium. The computer-readable storage medium stores instructions (or referred to as a computer program or a program). The instructions, when invoked and executed by a computer, cause the computer to perform the second aspect or any one possible design of the second aspect.

Those skilled in the art will easily come up with other implementation solutions of embodiments of the present disclosure after considering the specification and practicing the present disclosure disclosed herein. The present disclosure aims to cover any variation, uses, or adaptive changes of embodiments of the present disclosure, which follow general principles of the embodiments of the present disclosure and include common knowledge or customary technical means in the art not disclosed in the present disclosure. The specification and embodiments are only considered exemplary, and the true scope and spirit of embodiments of the present disclosure are indicated by the following claims.

It should be understood that embodiments of the present disclosure are not limited to the precise structure described above and shown in the accompanying drawings, and various modifications and changes may be made without departing from their scope. The scope of embodiments of the present disclosure is limited only by the appended claims.

### INDUSTRIAL UTILITY

In the methods of the present disclosure, for a plurality of PUSCHs scheduled by one piece of DCI, one uplink retransmission timer is run only for each group of PUSCHs, and the PDCCH for scheduling retransmission of the group of PUSCHs is monitored only during running of the timer. For the plurality of PUSCHs, the duration of monitoring the PDCCH may be reduced by reducing the number of running of uplink retransmission timers, thereby saving energy consumption of the user equipment.

1. A downlink receiving method, performed by user equipment and comprising:
running, for a plurality of physical uplink shared channels (PUSCHs) scheduled by one piece of downlink control information (DCI), one uplink retransmission timer for each group of PUSCHs; and
monitoring a physical downlink control channel (PDCCH) during running of the uplink retransmission timer, wherein the plurality of PUSCHs are divided into at least one group of PUSCHs, and each group of PUSCHs comprises one or more PUSCHs.

2. The method of claim 1, wherein the running one uplink retransmission timer for each group of PUSCHs, comprises:
running, for each group of PUSCHs, an uplink retransmission timer of an uplink hybrid automatic repeat request (HARQ) process corresponding to a first PUSCH in the group, where an ending time of the uplink retransmission timer corresponding to the first PUSCH comprises an ending time of a last PUSCH in the group.

3. The method of claim 1, wherein the running one uplink retransmission timer for each group of PUSCHs, comprises:
running, for each group of PUSCHs, an uplink retransmission timer of an uplink HARQ process corresponding to a last PUSCH in the group.

4. The method of claim 1, wherein the monitoring a PDCCH during running of the uplink retransmission timer, comprises:
when a plurality of HARQ processes corresponding to a group of PUSCHs require data retransmission, receiving, during running of an uplink retransmission timer corresponding to the group, DCI scheduling retransmission of the plurality of HARQ processes corresponding to the group.

5. The method of claim 1, further comprising:
receiving indication information sent by a network device, wherein the indication information indicates grouping information of the plurality of PUSCHs scheduled by the one piece of DCI.

6. The method of claim 5, wherein the receiving indication information sent by a network device, comprises one of:
receiving the DCI sent by the network device, wherein the DCI comprises the indication information; or
receiving higher layer signaling sent by the network device, wherein the higher layer signaling comprises the indication information.

7. The method of claim 5, wherein the grouping information comprises at least one of:
a number K of the at least one group;
a number M of PUSCHs scheduled by each piece of DCI; or
a maximum number N of PUSCHs in each group of PUSCHs.

8. The method of claim 7, wherein when K is 1, each group of PUSCHs comprises all of the plurality of PUSCHs scheduled by the one piece of DCI.

9. The method of claim 7, wherein the number of the PUSCHs scheduled by each piece of DCI is M, the number of the PUSCHs in each group of PUSCHs is less than or equal to the maximum number N, and the number K of the at least one group meets:
$$K = ⌈ \frac{M}{N} ⌉ .$$

10. The method of claim 9, wherein the number of PUSCHs in a last group of PUSCHs is:
$$M - ( ⌈ \frac{M}{N} ⌉ - 1 ) * N .$$

11. The method of claim 1, further comprising:
running, before running the one uplink retransmission timer for each group of PUSCHs, at least one round-trip-time timer for each group of PUSCHs;
wherein the running at least one round-trip-time timer for each group of PUSCHs, comprises: running a round-trip-time timer corresponding to the one uplink retransmission timer; or running round-trip-time timers corresponding to all of PUSCHs in each group of PUSCHs.

12. (canceled)

13. A downlink sending method, performed by a network device and comprising:
sending a physical downlink control channel (PDCCH) during running of one uplink retransmission timer for each group of physical uplink shared channels (PUSCHs), wherein each group of PUSCHs is all or a part of PUSCHs scheduled by one piece of downlink control information (DCI).

14. The method of claim 13, wherein the sending a PDCCH during running of one uplink retransmission timer for each group of PUSCHs, comprises:
sending the PDCCH during running of an uplink retransmission timer corresponding to a first PUSCH in each group of PUSCHs; wherein an ending time of the uplink retransmission timer corresponding to the first PUSCH comprises an ending time of a last PUSCH in the group in which the first PUSCH is located.

15. The method of claim 13, wherein the sending a PDCCH during running of one uplink retransmission timer for each group of PUSCHs, comprises:
sending the PDCCH during running of an uplink retransmission timer of an uplink hybrid automatic repeat request (HARQ) process corresponding to a last PUSCH in each group of PUSCHs.

16. The method of claim 13, wherein the sending a PDCCH during running of one uplink retransmission timer for each group of PUSCHs, comprises:
when a plurality of HARQ processes corresponding to a group of PUSCHs require data retransmission, sending, during running of the one uplink retransmission timer, DCI scheduling retransmission of the plurality of HARQ processes.

17. The method of claim 13, further comprising:
sending indication information to user equipment, wherein the indication information indicates grouping information of the plurality of PUSCHs scheduled by the one piece of DCI;
wherein the sending indication information to user equipment, comprises one of: sending the DCI to the user equipment, wherein the DCI comprises the indication information; or sending higher layer signaling to the user equipment, wherein the higher layer signaling comprises the indication information.

18.-21. (canceled)

22. A communication apparatus, comprising: a processor and a memory; wherein
the memory is configured to store a computer program; and
the processor is configured to execute the computer program to:
run, for a plurality of physical uplink shared channels (PUSCHs) scheduled by one piece of downlink control information (DCI), one uplink retransmission timer for each group of PUSCHs; and
monitor a physical downlink control channel (PDCCH) during running of the uplink retransmission timer, wherein the plurality of PUSCHs are divided into at least one group of PUSCHs, and each group of PUSCHs comprises one or more PUSCHs.

23. A communication apparatus, comprising: a processor and a memory; wherein
the memory is configured to store a computer program; and
the processor is configured to execute the computer program to implement the method of claim 13.

24. A non-transitory computer-readable storage medium, storing instructions, wherein the instructions, when invoked and executed by a computer, cause the computer to perform the method of claim 1.

25. A non-transitory computer-readable storage medium, storing instructions, wherein the instructions, when invoked and executed by a computer, cause the computer to perform the method of claim 13.
